(19) United States
(12) Patent Application Publication
(10) Pub. No.: US 2009/0057501 A1
(43) Pub. Date: Mar. 5, 2009

(54) DISPLAY EXHIBITION FRAME

(76) Inventor: Ming Hug Huang, Kaohsiung (TW)

Correspondence Address: Ming Hug Huang, 235 Chung - Ho, Box 8-24, Taipei, TW

(21) Appl. No.: 11/849,353

(22) Filed: Sep. 3, 2007

(51) Int. Cl. F16M 11/00

(52) U.S. Cl. 248/157

(57) ABSTRACT

A display exhibition frame comprises a seat having two insertion holes at two sides; each insertion hole being installed with a supporting post; at least one receiving plate; each receiving plate being supported by two supporting arms; each supporting arm having a connecting hole; thus, in assembly, the supporting post passing through the connecting hole; a stud locking the supporting arm to the supporting post from the backside of the connecting hole; thus, by releasing the stud, the elevation of the supporting arm being adjustable; a display suspending frame being installed on the supporting posts; the supporting post including a first suspending frame and a second suspending frame; the first suspending frame having two through holes so as to receive the two supporting posts; the second suspending frame being a frame for locking a display; and the second suspending frame being able to be fixed to the first suspending frame.

### FIELD OF THE INVENTION

The present invention relates to installation of a display, and particularly to a display exhibition frame, which can be assembled easily. The structure of the present invention is stable and the elevation of the display suspending frame is adjustable. Furthermore, at least one receiving plate is provided for storing different objects thereon.

### BACKGROUND OF THE INVENTION

Flat plate displays, such as plasma displays, or LCD displays have become current trend in displays. However this kind of displays is thin and thus it is compact. The flat plate displays are suitable for being suspended from walls or ceilings. However the prior art display suspending frame has no concrete structure so that the display retained thereon can not be protected well. Furthermore, there are many devices related to the displays, which are necessary to be stored near the display, but the display suspending frame do not provide sufficient space for receiving these objects, such as audio players, VCDs, DVDs, etc.

### SUMMARY OF THE INVENTION

Accordingly, the primary object of the present invention is to provide a display exhibition frame, wherein can be assembled easily. The structure of the present invention is stable and the elevation of the display suspending frame is adjustable. Furthermore, at least one receiving plate is provided for storing different objects thereon.

To achieve above objects, the present invention provides a display exhibition frame comprising: a seat having two insertion holes at two sides; each insertion hole being installed with a supporting post; the supporting post being vertically extended from the insertion hole; at least one receiving plate; each receiving plate being supported by two supporting arms so that the receiving plate can be supported to the two supporting posts; each supporting arm having a connecting hole; thus, in assembly, the supporting post passing through the connecting hole; a stud locking the supporting arm to the supporting post from the back side of the connecting hole; thus, by releasing the stud, the elevation of the supporting arm being adjustable so as to adjust the elevation of the receiving plate; a display suspending frame being installed on the supporting posts; the supporting post including a first suspending frame and a second suspending frame; the first suspending frame having two through holes so as to receive the two supporting posts; the second suspending frame being a frame for locking a display; the second suspending frame being able to be fixed to the first suspending frame; a stud serving to lock the first suspending frame to the supporting post from the back side of the through hole; the stud passing through a hole which is communicated to the through hole; thus, by releasing the stud, the elevation of the first suspending frame is adjustable so as to adjust the elevation of the display suspending frame.

The various objects and advantages of the present invention will be more readily understood from the following detailed description when read in conjunction with the appended drawing.

### BRIEF DESCRIPTION OF THE DRAWINGS

FIG. 1 is an assembled view of the present invention.

FIG. 2 is an exploded perspective view of the seat and the supporting posts of the present invention.

FIG. 3 is an elevational view showing the assembly of the seat and the supporting posts according to the present invention.

FIG. 4 is an exploded perspective view of the receiving plates of the present invention.

FIG. 5 is an assembled cross sectional view of the receiving plate of the present invention and a cross sectional view along line I-I.

FIG. 6 is an exploded perspective view of the display suspending frame of the present invention.

FIG. 7 is an assembled cross sectional view of the display suspending frame of the present invention and a cross sectional view along line II-II.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

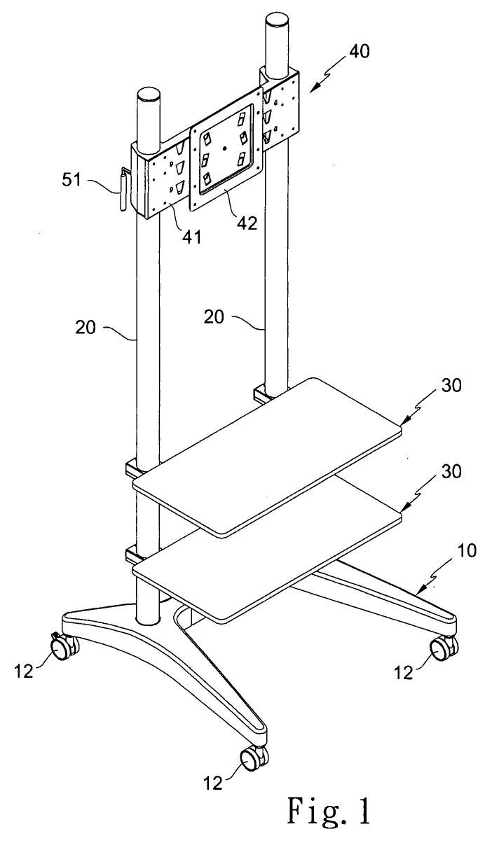

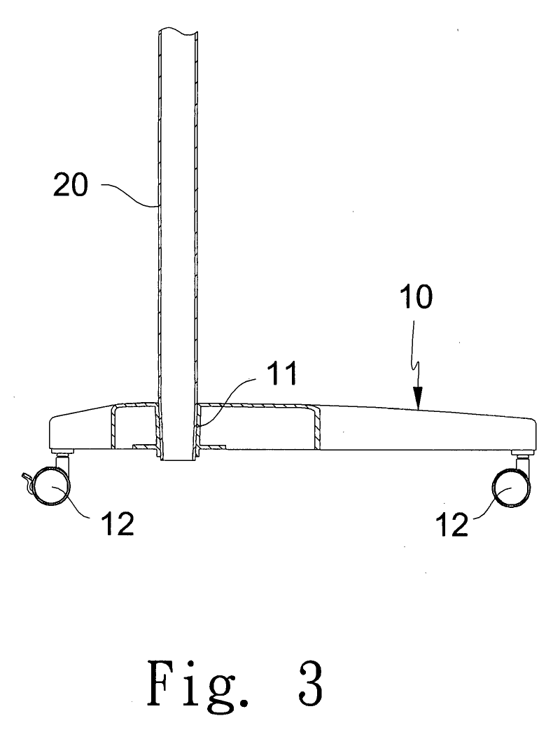

Referring to FIGS. 1 to 7, the structure of the present invention will be described herein.

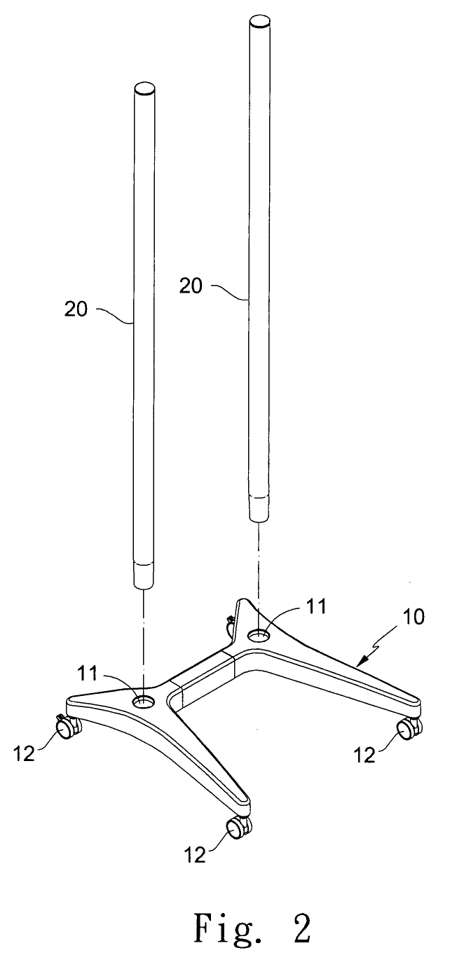

A seat 10 (see FIGS. 2 and 2) has two sides. Each side thereof has at least one insertion hole 11 which is a tapered hole with a larger upper end and a small lower end.

Each insertion hole 11 is installed with a supporting post 20. The supporting post 20 is vertically extended from the insertion hole 11. A lower end of the supporting post 20 has a tapered shape corresponding to the insertion hole 11 of the seat 10.

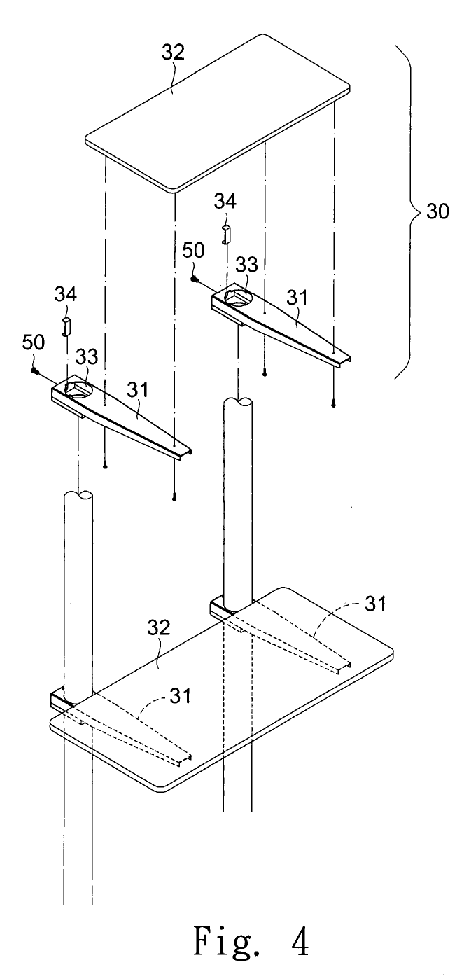

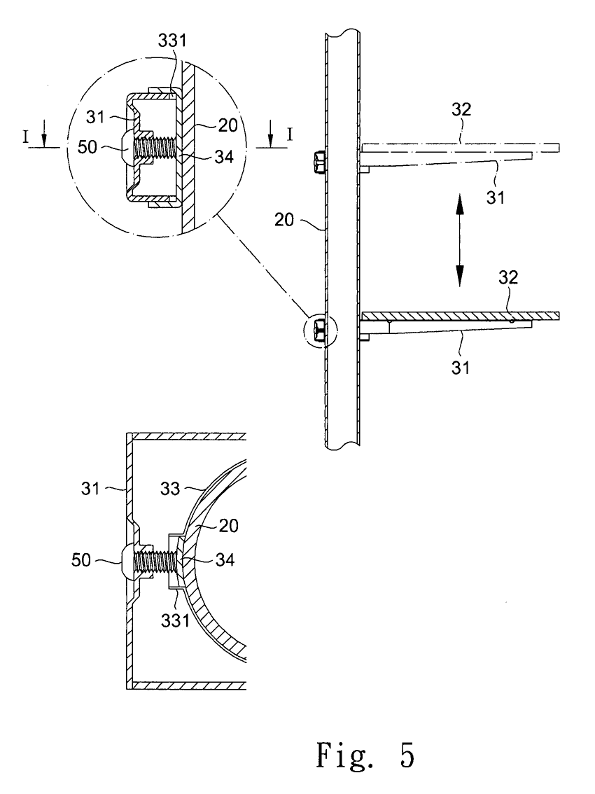

At least one receiving plate 30 (referring to FIGS. 4 and 5) is included. Each receiving plate 30 is supported by two supporting arms 31 so that the receiving plate 30 can be supported to the two supporting posts 20. Each supporting arm 31 has a connecting hole 33. A periphery of the connecting hole 33 is formed with a notch 331. A U shape pad 34 is located in the notch 331 with two ends of the pad 34 being out of the notch 331. Thus, in assembly, the supporting post 20 passes through the connecting hole 33 while the pad 34 is installed in the notch 331 so as to make the supporting post 20 is tightly engaged to the supporting arm 31. A stud 50 serves to lock the supporting arm 31 to the supporting post 20 from the back side of the connecting hole 33. The stud 50 passes through a hole which is communicated to the notch 331. The stud 50 will compress the pad 34 to attach to the supporting post 20. Thus, by releasing the stud 50, the elevation of the supporting arm 31 is adjustable so as to adjust the elevation of the receiving plate 30.

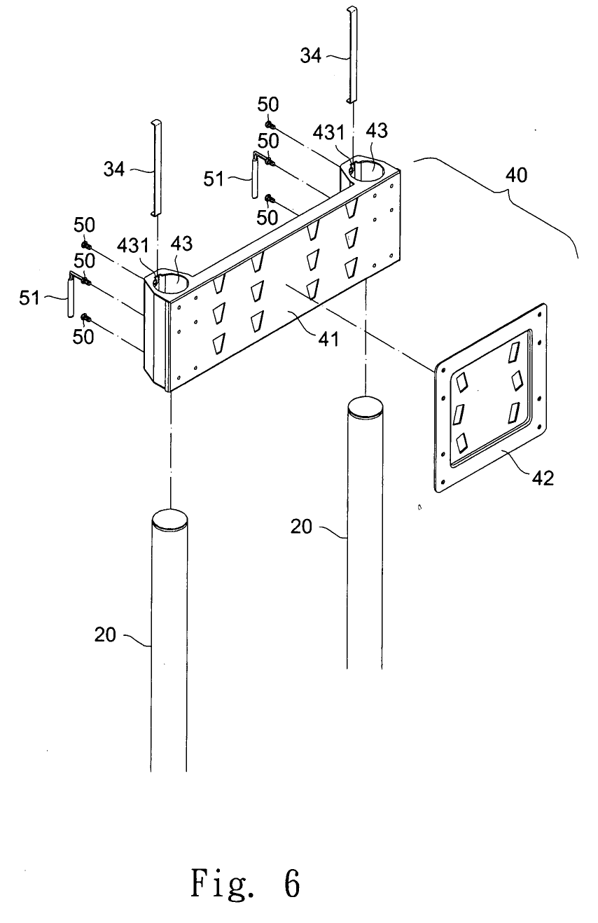

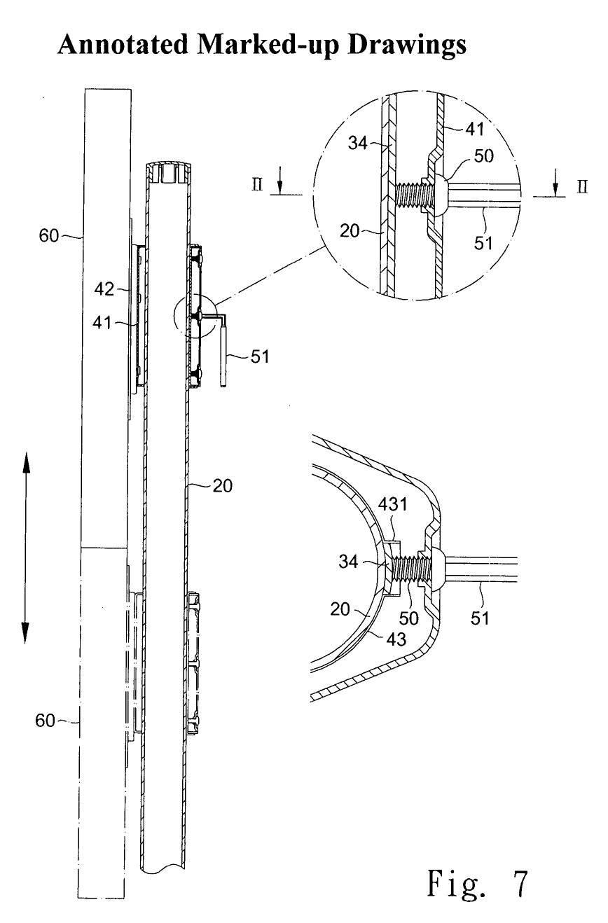

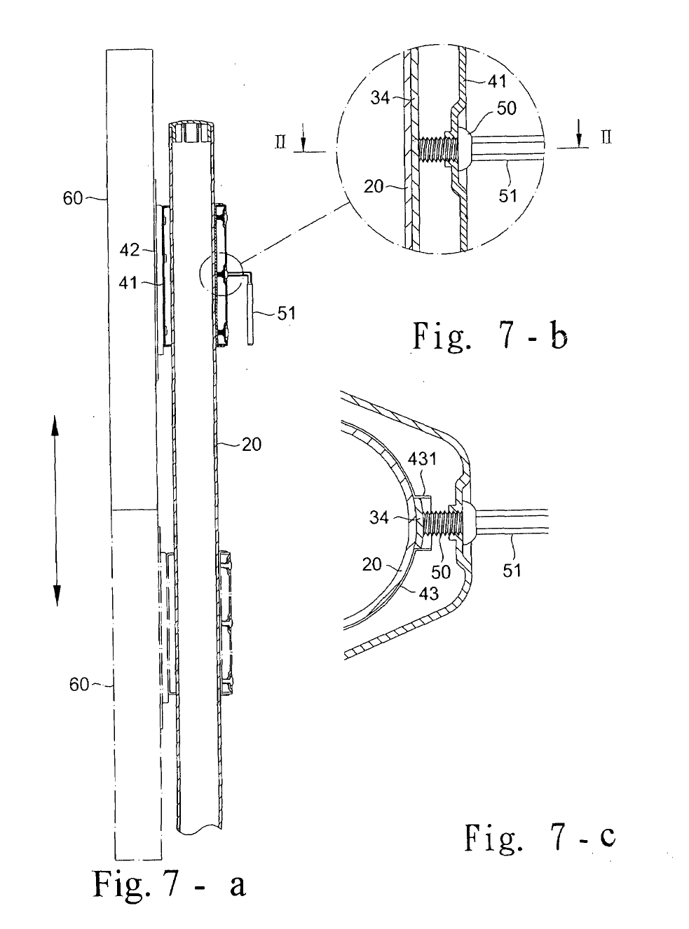

A display suspending frame 40 (referring to FIGS. 6 and 7) is installed on the supporting posts 20. The supporting post 20 includes a first suspending frame 41 and a second suspending frame 42. The first suspending frame 41 has two through holes 43 so as to receive the two supporting posts 20. Each through hole 43 of the first suspending frame 41 has a notch 431. A U shape pad 43 is installed in the notch 431 with two ends of the pad 43 protruded from the through hole 43. The second suspending frame 42 is a frame for locking a display 60. The second suspending frame 42 is able to be fixed to the first suspending frame 41. A stud 50 serves to lock the first suspending frame 41 to the supporting post 20 from the backside of the through hole 43. The stud 50 passes through a hole which is communicated to the notch 431. The stud 50 will compress the pad 43 to the be attached to the supporting post 20. Thus, by releasing the stud 50, the elevation of the first suspending frame 41 is adjustable so as to adjust the elevation of the display suspending frame 40.

The seat 10 is installed with at least two wheels 12 so as to move the display exhibition frame freely.

Preferably, to make the first suspending frame 41 being firmly secured to the supporting posts 20, two studs 50 are used to lock the first suspending frame 41 to one supporting post 20. Each stud 50 is connected to a crank 51 so that the user can hole the crank 51 to drive the stud 50 to rotate.

Advantages of the present invention will be described herein.

The present invention has a simple structure which can be assembled easily. The heights of the receiving plates 30 and the display suspending frame 40 are adjustable (referring to FIGS. 5 to 7).

The pads 34 serve to enforce the supporting arms 31 to the supporting posts 20 and the studs 50 compress the pads 43 so that the supporting posts 20 will not deform.

The seat 10 has a plurality of wheels 12 so that the display exhibition frame of the present invention can be moved freely.

The number of the receiving plates 30 is adjustable as desired. Thus a sufficient space is provided for placing required objects, such as an audio player, etc.

Furthermore, the crank 51 will provide convenience to the operator for releasing or tightening the studs 50

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A display exhibition frame comprising:
a seat having two insertion holes at two sides;
each insertion hole being installed with a supporting post; the supporting post being vertically extended from the insertion hole;
at least one receiving plate; each receiving plate being supported by two supporting arms so that the receiving plate can be supported to the two supporting posts; each supporting arm having a connecting hole; thus, in assembly, the supporting post passing through the connecting hole; a stud locking the supporting arm to the supporting post from the back side of the connecting hole; thus, by releasing the stud, the elevation of the supporting arm being adjustable so as to adjust the elevation of the receiving plate;
a display suspending frame being installed on the supporting posts; the supporting post including a first suspending frame and a second suspending frame; the first suspending frame having two through holes so as to receive the two supporting posts; the second suspending frame being a frame for locking a display; the second suspending frame being able to be fixed to the first suspending frame; a stud serving to lock the first suspending frame to the supporting post from the back side of the through hole; the stud passing through a hole which is communicated to the through hole; thus, by releasing the stud, the elevation of the first suspending frame is adjustable so as to adjust the elevation of the display suspending frame.

2. The display exhibition frame as claimed in claim 1, wherein the insertion hole is a tapered hole with a larger upper end and a small lower end.

3. The display exhibition frame as claimed in claim 1, wherein a bottom of the seat is installed with at least one wheel.

4. The display exhibition frame as claimed in claim 1, wherein a lower end of the supporting post has a tapered shape corresponding to the insertion hole of the seat.

5. The display exhibition frame as claimed in claim 1, wherein a periphery of the connecting hole is formed with a notch; a U shape pad is located in the notch with two ends of the pad being out of the notch; and a pad is installed in the notch so as to make the supporting post is tightly engaged to the supporting arm; the stud passes through a hole which is communicated to the notch; the stud will compress the pad to the be attached to the supporting post.

6. The display exhibition frame as claimed in claim 1, wherein each through hole of the first suspending frame has a notch; a U shape pad is installed in the notch with two ends of the pad protruded from the through hole; and the stud will compress the pad to the be attached to the supporting post.

7. The display exhibition frame as claimed in claim 6, wherein a crank is installed to the stud for driving the stud.
